(19) United States
(12) Patent Application Publication
(10) Pub. No.: US 2023/0063419 A1
(43) Pub. Date: Mar. 2, 2023

(54) SYSTEM AND METHOD FOR MANAGING PERFORMANCE OF A VEHICLE BASED ON TERRAIN

(71) Applicant: Hyliion Inc., Cedar Park, TX (US)

(72) Inventors: Addie Gisser, Leander, TX (US); George James Noland, Sarver, PA (US); Ryan Wostarek, Pflugerville, TX (US); Dave Jay Mullinix, Austin, TX (US); Donald Dean Binford, JR., Cedar Park, TX (US)

(21) Appl. No.: 17/461,175

(22) Filed: Aug. 30, 2021

(51) Int. Cl. G01C 21/34; B60W 20/20; B60W 20/40

(52) U.S. Cl. CPC G01C 21/3461; G01C 21/3492; B60W 20/20; B60W 20/40

(57) ABSTRACT

A system and method for adjusting an operating parameter on a vehicle or a set of vehicles comprises accessing route data and compressing the route data into a plurality of linearized segments. Each segment is determined by analyzing points along the route to determine when a set of points indicates an uphill, downhill or flat segment. Using the segment information, configuration information for a vehicle and a weight of the vehicle, embodiments determine a performance plan that is tailored to the vehicle. The vehicle operates in accordance with the performance plan based on cost, environmental impact or extending vehicle operating life.

### BACKGROUND

### Field of the Disclosure

This disclosure relates generally to controlling operation of drivetrains in large vehicles and, more particularly, to controlling hybrid drivetrains installed in large vehicles configured for transporting cargo of different weights over routes of varying terrain.

### Description of the Related Art

Large vehicles may be used to efficiently transport cargo. Large, wheeled vehicles generally comprise a chassis with an internal combustion engine. The chassis is either configured with an integrated cargo compartment (often referred to as a box truck) or is configured for coupling to a trailer comprising the cargo compartment (wherein the combination may be referred to as a tractor-trailer). Tractor-trailers are used to transport large volumes of cargo on land, wherein the combination of the tractor and the trailer can weigh between 30,000 pounds empty up to 140,000 pounds for a tandem loaded trailer. Tractor-trailers may be used on roads with improved surfaces such as highways and in urban areas but may also be used on roads with unimproved surfaces such as gravel and sand. In a traditional chassis, the internal combustion engine may be sized in the range of 15 liters to provide enough power to drive a tractor-trailer with cargo over long distances and on roads of varying grades.

### SUMMARY

Vehicles with hybrid drivetrains containing an engine and a motor/generator may be configured with unique configurations capable of integrating one of several different types of engines to generate electric power for charging an array of batteries under a wide range of operating conditions. A drivetrain for a large wheeled vehicle may be configured according to a unique configuration capable of integrating an existing drivetrain with one of several different types of engines.

Embodiments may be generally directed to a method for controlling operation of a hybrid drivetrain in a vehicle based on a set of operating parameters. The method may include receiving route data for a route over which the vehicle will travel, determining a route distance based on the route data and determining a plurality of segments based on the route data. Embodiments may determine, for each segment, segment information comprising a segment distance and a segment grade.

The method may include determining a configuration for a vehicle drivetrain, wherein the vehicle drivetrain comprises an engine capable of generating rotational power having an engine output power, a battery system, and a motor/generator configurable as a generator to convert rotational power received from the engine to electrical power and configurable as a motor to convert electrical power received from the battery system to rotational power to drive the vehicle.

The method may include generating a performance plan for a vehicle having the vehicle configuration and communicating the performance plan to the vehicle. The performance plan identifies a first set of segments over which the vehicle is configured with the motor/generator configured to operate as the motor to drive the vehicle and identifies a second set of segments over which the motor/generator is configured to operate as the generator to generate electric power.

In some embodiments, the performance plan identifies a set of segments over which the vehicle is configured with the engine generating rotational power to drive the vehicle and supply rotational power to the motor/generator configured to operate as the generator to charge the battery system.

In some embodiments, the performance plan identifies a set of segments over which the vehicle is configured with the motor/generator configured to operate as the generator and configured to receive rotational power from an axle to generate electric power to charge the battery system.

In some embodiments, the method comprises: determining, for the route, a segment having an uphill grade; determining a vehicle weight for the vehicle; determining, based on the vehicle weight: an output power needed by the motor/generator configured as a motor to generate rotational power to drive the vehicle over the segment; a change in a battery state of charge caused by the battery system supplying electric power to the motor/generator to drive the vehicle over the segment; a minimum engine output power needed to generate rotational power to drive the vehicle over the segment; and a minimum engine output power needed to generate rotational power to generate electric power for supplying to the motor/generator to drive the vehicle over the segment. Generating the performance plan may further comprise determining an operating cost, an environmental impact and change in battery temperature over the segment; and selecting a vehicle configuration based on one or more of the operating cost, the environmental impact and the change in battery temperature.

In some embodiments, the method comprises: determining, for the route, a segment having a downhill grade; determining a vehicle weight for the vehicle; determining, based on the vehicle weight: an electric power generated by the motor/generator configured as a generator; and a change in a battery state of charge caused by the motor/generator configured to supply electric power to the battery system over the segment, wherein generating the performance plan further comprises: determining an operating cost, an environmental impact and change in battery temperature over the segment; and selecting the set of operating parameters for the vehicle based on one or more of the operating cost, the environmental impact and the change in battery temperature.

In some embodiments, the method comprises communicating with a controller on the vehicle to receive an operating parameter of the vehicle. In some embodiments, the method comprises determining a cargo load, wherein generating the performance plan is based on the vehicle configuration and the cargo load. In some embodiments, the method comprises determining segment information including one or more of a road surface, a road type and a traffic rating for a segment.

Embodiments may be generally directed to a method for compressing a set of route data into a plurality of linearized segments. The method may comprise determining a route start point and a route end point for the route data and determining a plurality of segments between the start point and the end point. Determining a segment may comprise identifying a segment start point as a first point; determining a distance between the first point and a second point; determining a first grade between the first point and the second point; determining the segment is one of: an uphill segment based on the first grade being greater than a minimum grade associated with an uphill segment, a downhill segment based on the first grade being less than a maximum grade associated with a downhill segment, or a flat segment based on the first grade being less than the minimum grade associated with an uphill section and greater than the maximum grade associated with a downhill segment.

Embodiments may be generally directed to a system for communicating a performance plan for controlling a set of operating parameters of a vehicle. The system may comprise: a route planning server configured to store route data and compress the route data into a plurality of linearized segments; a vehicle configuration server configured to store vehicle configuration information; a cargo tracking server configured to determine cargo load information for a plurality of cargo loads; a power planning server configured to determine a set of fuel locations and charging station locations for receiving fuel or electric power; and an operations server. The operations server may be configured to: communicate with the route planning server to determine, from the route data, a plurality of segments; communicate with the vehicle configuration server to determine a configuration of the vehicle, the configuration comprising an engine, a motor/generator and a battery system; communicate with the cargo tracking server to determine a cargo load to be transported by the vehicle; and communicate with the power planning server to determine one of a fuel location or a charge station location for the vehicle.

The route planning server may be configured to communicate with a GPS source server to get the route data. The power planning server may be configured to: communicate with the vehicle to determine a range of the vehicle; communicate with the operations server to determine a cost associated with adding fuel and a cost associated with charging the battery system; and determine a set of fuel locations and a set of battery charging locations based on the range, the cost associated with adding fuel and a cost associated with charging the battery system.

In some embodiments, the vehicle may comprise a controller configured to: communicate with a set of sensors on the vehicle to determine a set of operating parameters for the vehicle; and communicate the set of operating parameters to the operations server. The operations server may be configured to determine a segment corresponding to the vehicle; and determine, based on the segment corresponding to the vehicle, the set of operating parameters received from the vehicle, the weight of the vehicle and the cargo information, a performance plan specifying a set of operating parameters to control the vehicle. The controller may be configured to receive the performance plan and operate the vehicle according to the performance plan. In some embodiments, the controller is configured to communicate with the operations server periodically to receive an update to the performance plan. In some embodiments, the controller is configured to operate the vehicle according to a most recent performance plan if a performance plan is not received from the operations server.

In one aspect, a vehicle comprises a chassis having a frame, a cab, an engine compartment and a plurality of axles coupled to the frame. The vehicle further comprises a drivetrain including an engine, a motor/generator for coupling to the engine, a battery system containing an array of batteries, and a regenerative braking system for converting rotational power from the axles into electrical power to charge the battery system. The vehicle also comprises a controller configured to monitor the operating temperature of the battery system, monitor one or more environmental conditions, monitor a set of operating parameters of the engine, and operate one or more of the engine and the motor/generator based on the operating parameters of the battery system, the one or more environmental conditions and the set of operating parameters of the engine coupled to the generator.

### BRIEF DESCRIPTION OF THE DRAWINGS

For a more complete understanding of the present invention and its features and advantages, reference is now made to the following description, taken in conjunction with the accompanying drawings, in which:

FIG. 1 depicts a block diagram of a system for determining a configuration of a drivetrain in a vehicle and communicating a performance plan for controlling the vehicle;

FIG. 2 depicts a data structure containing route data representing a route;

FIG. 3 depicts a data structure containing segment information determined from compressing a route;

FIG. 4 depicts a flow diagram illustrating a portion of a method for compressing route data into a set of linearized segments;

FIG. 5 depicts a data structure containing vehicle configuration information;

FIG. 6 depicts a data structure containing performance plans for a plurality of vehicles;

FIG. 7 is a graphical representation of a plurality of routes in a geographic area;

FIG. 8 depicts a data structure containing cargo load information;

FIG. 9 depicts a flow diagram of one embodiment of a method for communicating a performance plan to a vehicle or plurality of vehicles based on a route, vehicle configuration information and cargo load information;

FIG. 10 depicts a flow diagram of one embodiment method for determining a cost to charge a vehicle; and

FIG. 11 depicts a flow diagram of one embodiment of a method for determining a cost to charge a vehicle based on converting fuel into electricity.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, embodiments are described as they pertain to a large, wheeled vehicle having a chassis with a drivetrain comprising an engine, a motor/generator configurable as a motor or a generator and a battery system comprising a plurality of batteries. Embodiments may also pertain to other wheeled vehicles with more or fewer axles and other vehicles including, for example, box trucks and buses.

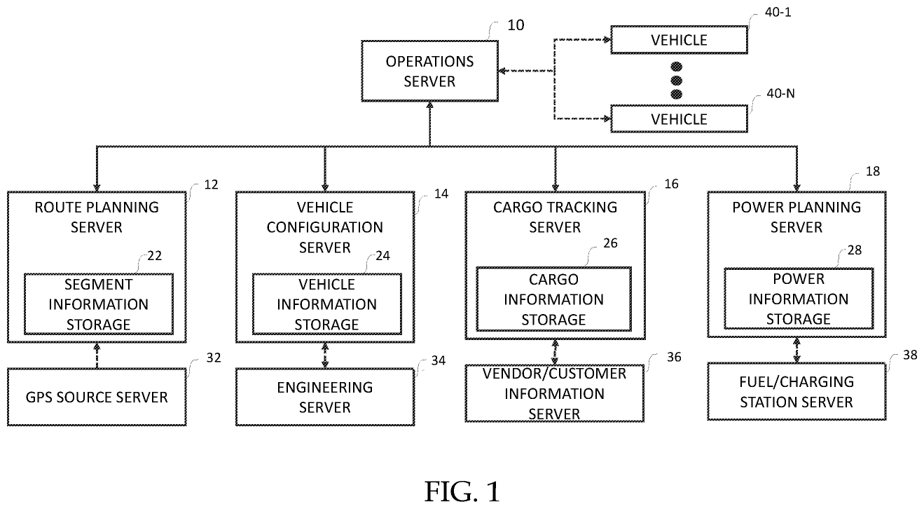

Particular embodiments may be best understood by reference to FIGS. 1-11, wherein like numbers are used to indicate like and corresponding parts.

### System Overview

Turning now to the drawings, a system for controlling a vehicle may include an operations server 10 communicatively coupled to route planning server 12, vehicle configuration server 14, cargo tracking server 16 and power planning server 18. Operations server 10 may also communicate with one or more vehicles 40 to receive information about a vehicle 40 and/or send instructions to the vehicle 40 to adjust an operating parameter based on reducing a cost to operate the vehicle 40, reduce emissions by the vehicle or for increasing a service life of the vehicle 40.

Operations server 10 may store information associated with vehicles 40 used to transport cargo. Operations server 10 may also store information associated with operations of a business, including managing costs associated with transporting cargo loads and managing the delivery of cargo loads in the form of materials and supplies from a vendor and delivering end items and products to customers.

Route planning server 12 may communicate with operations server 10 to get route planning information and route data about one or more routes for a vehicle 40. The route planning information may include a starting point and an end point for a vehicle 40, speed limit information for each possible route, traffic information for each possible route, weather information for each possible route and toll road information. In some embodiments, route information may include information about fuel station locations, charging location or other stopover locations in the vicinity of a starting point, an end point, or a stopover location. In some situations, a starting point may be a location such as a central warehouse and an end point may be a retail location, but a vendor location may be a starting point and the central warehouse may be the end point. Route planning server 12 uses route planning information and route data to determine one or more routes over which vehicles 40 may travel from the starting point to the end point. Route planning server 12 may communicate with a GPS source server 32 to retrieve route data, analyze the route data and store the analyzed route data in segment information storage 22. Route planning server 12 may communicate results of any analysis to operations server 10.

Vehicle configuration server 14 may communicate with operations server 10, engineering server 34 and vehicles 40 to get vehicle configuration information about one or more vehicles 40. Vehicle configuration server 14 may communicate with engineering server 34 to get operating parameters for a vehicle 40 or type of vehicle 40. For example, engineering server 34 may contain information about an engine output parameter for a type of engine, information about a service life for an engine or motor and engine emission levels for various operating conditions. Vehicle configuration server 14 may communicate with a particular vehicle 40 to get information about a configuration in which vehicle 40 is operating or can operate. In some embodiments, when a vehicle 40 starts, it communicates a set of operating parameters to the vehicle configuration server. The operating parameters may include parameters that might not change, such as a vehicle base weight and a chassis type and may also include parameters that change such as a fuel level and a battery state of charge. Vehicle configuration information may be stored in vehicle information storage 24.

Cargo tracking server 16 may communicate cargo load information to operations server 10. Cargo load information may include the type of cargo, a weight, any information specific to the cargo load (e.g., if a cargo load requires refrigeration, if there is hazardous material, if the cargo load must be delivered by a deadline, etc.). In some embodiments, a user may enter information for storing in cargo information storage 26. In some embodiments, cargo tracking server 16 may communicate over a network with vendor/customer information servers 36 associated with vendors, merchants or other external parties to get cargo load information. Cargo tracking server 16 may store cargo load information in cargo information storage 26.

Power planning server 18 may communicate with operations server 10 to determine a maximum cost associated with transporting cargo loads and communicate with fuel stations and charging stations to identify one or more locations where fuel may or should be acquired. In some embodiments, power planning server 18 may communicate over a network with fuel/charging station servers 38 associated with third parties (external sources) or associated with facilities (internal sources) to get fuel/charging information. Power planning server 18 may get information about fuel cost, a wait time for availability of a pump, a number of pumps at a fuel station, an electric power cost (including variations in charging cost due to peak demand, off demand, holiday and weekday or weekend rates), a wait time for availability for a charging station, a number of charging stations, a rate at which charging can occur and store the information in power information storage 28.

Operations server 10 may communicate with other systems as well. For example, operations server 10 may communicate with a warehouse server to determine how much time a vehicle 40 stays at the warehouse, communicate with a traffic server to identify traffic or traffic patterns, communicate with a weather server to get updates on weather, and communicate with a satellite imagery server to get information about a route.

In some embodiments, operations server 10 may communicate instructions to one or more of route planning server 12, vehicle configuration server 14, cargo tracking server 16, power planning server 18, GPS source server 32, engineering server 34, vendor/customer information server 36 and fuel/charging station server 38 to send information and operations server 10 may perform calculations and execute processes for determining a set of operating parameters for controlling one or more vehicles 40 and communicate a set of operating parameters to each of the one or more vehicles 40.

In some embodiments, operations server may communicate instructions to one or more of route planning server 12, vehicle configuration server 14, cargo tracking server 16, power planning server 18, GPS source server 32, engineering server 34, vendor/customer information server 36 and fuel/charging station server 38 to perform calculations, execute processes for determining a set of operating parameters for controlling one or more vehicles 40, and communicate the set of operating parameters for controlling one or more vehicles 40 to operations server 10, wherein operations server 10 communicates a set of operating parameters to each of the one or more vehicles 40.

Operations server 10 may communicate with a single vehicle 40 or a fleet of vehicles 40 to control operation of the vehicle over a route or set of routes. A fleet may be as small as two vehicles 40 but fleets may also have more than a hundred vehicles 40.

As described herein, control of a vehicle 40 may be limited to communicating a set of operating parameters of the vehicle 40. In some embodiments, control of a vehicle 40 may be limited to communicating a set of operating parameters to limit the rotational power available to a set of axles based on reducing operating cost of the vehicle, reducing emissions caused by operating the vehicle 40 to minimize the environmental impact caused by the vehicle 40 and extending the service life for the vehicle 40. For example, route information may include speed limit information indicating a speed limit over a route may be 65 miles per hour and a vehicle 40 may be traveling over the route at 45 miles per hour because the driver does not want to travel at 65 miles per hour (there may be bad weather, poor visibility, an accident, road maintenance, etc.) Embodiments may determine a set of operating parameters for the vehicle 40 based on the vehicle speed and do not send instructions to accelerate the vehicle 40.

Embodiments may determine a set of operating parameters for a vehicle 40 based on a route that the vehicle 40 is expected to use. In some embodiments, a method for controlling a vehicle 40 may be based in part on route points.

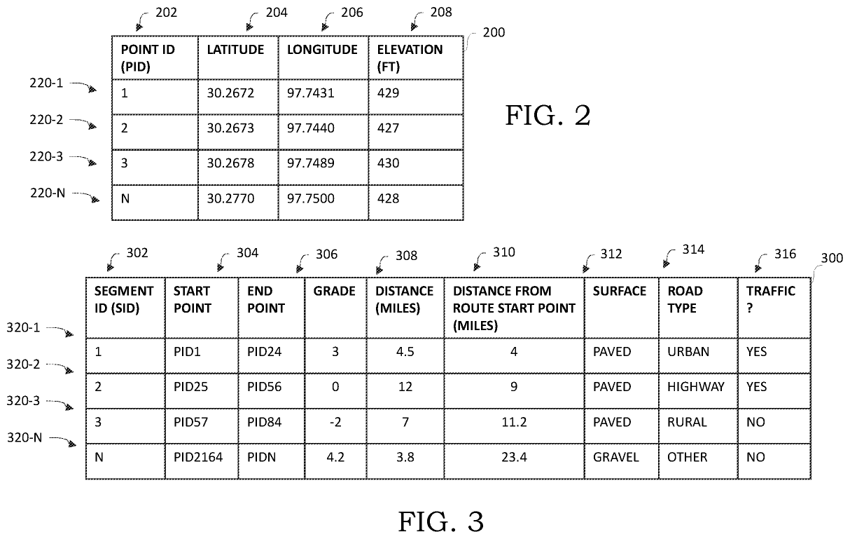

FIG. 2 depicts a data structure 200 comprising a plurality of route points 220. Each route point 220 may have a route point identifier (ID) 202 and correspond to a latitude value 204, a longitude value 206 and an elevation 208. Route data may be retrieved from an outside source (such as GPS source server 32) and contain a large plurality of route points. For example, points 220 may be separated from adjacent points 220 by approximately 30 feet. For a 25 mile route, the route data stored in data structure 200 can exceed 4000 route points 220 such that calculations quickly become too difficult to perform.

### Route Data is Difficult to Use

Using route data with thousands of points 220 in calculations to determine a control strategy or performance plan for vehicles 40 is computationally expensive. Furthermore, there may be variations or inconsistencies in points 220, making the route data difficult to analyze. For example, referring to data structure 200, point 220-3 identified as point ID_3 has a higher elevation than adjacent points 220-2 and 220-4 (and has the highest overall elevation of 430 ft) and point 220-2 has a lower elevation than adjacent points 220-1 and 220-3.

Route Compression into Linearized Segments

Embodiments may compress route data into linearized segments, wherein each segment has a distance and grade between a start point and an end point. Segments in a route may vary in distance. Thus, the number of points corresponding to a segment may also vary.

FIG. 3 depicts a data structure 300 comprising segment information for a plurality of segments 320 based on route points 220 from data structure 200. Data structure 300 may contain segment information derived from thousands of route points 220. Data structure 300 may contain other information as well. For example, data structure 300 may contain, for each segment 320, a segment identifier (ID) 302, segment start point 304, segment end point 306, grade 308, segment distance 310, segment surface type 312, segment road type 314 and other information including but not limited to traffic information 316, speed limit information, weather information and toll information. For the example mentioned with respect to FIG. 2, a data structure of 39 segments was developed to represent a 25 mile route having 4082 route points, representing a 99% decrease in the number of calculations needed to perform additional processing.

A method for compressing a route into linearized segments may comprise analyzing points (such as points 220 in data structure 200) to identify uphill, downhill and flat segments 320.

### Determining Uphill/Downhill Segments

Uphill segments are defined as segments 320 of a route over which the average grade exceeds a minimum grade threshold and the segment 320 spans a distance greater than a defined minimum distance.

Downhill segments are defined as segments 320 of a route over which the average grade is less than a defined downhill threshold and the segment 320 spans a distance greater than a defined minimum distance.

Starting at a first point at the beginning of the route, embodiments analyze adjacent points for a potential start of an uphill segment. Any grade between adjacent points that exceeds the minimum grade threshold for an uphill segment is a potential start of an uphill segment. A potential uphill is investigated to determine if it meets the minimum distance and grade requirements. Exceptions are identified for short segments between two points where the grade falls below the minimum grade threshold. If the number of exceptions does not exceed a defined maximum number of exceptions, the investigation of this hill continues. If the thresholds for grade and distance are satisfied and the allowed exception limit is not exceeded, an uphill has been identified.

At this point the end of the confirmed uphill needs to be identified to complete the uphill segment. This is done by finding a consecutive span of the path where the average grade requirement is less than the minimum grade threshold. Once the end of an uphill segment has been determined, segment information is saved and the search process continues from the point after the last point identified in the previous uphill segment. The uphill segment is saved with the distance from the start of the route to the starting point, the segment distance, the segment end point and the segment average grade.

If a potential uphill/downhill segment fails to meet the requirements, route analysis continues from the point at which the potential uphill/downhill segment failed to meet the requirements.

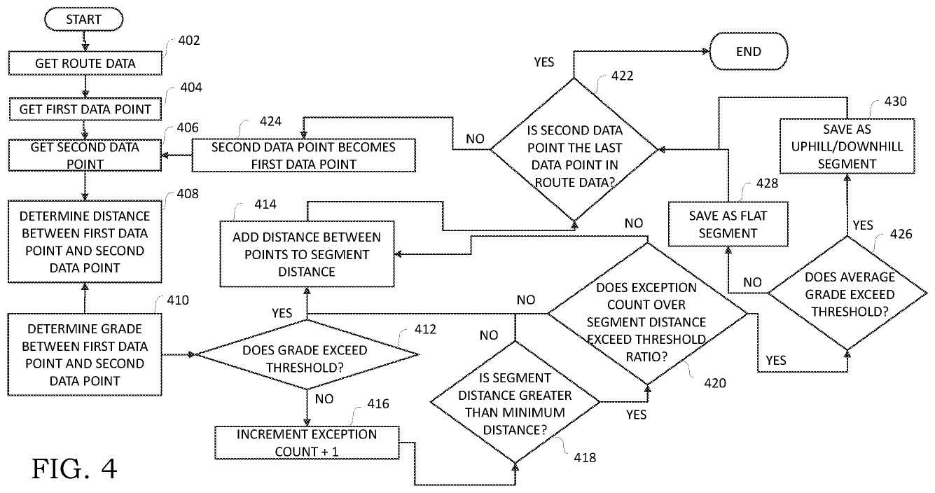

FIG. 4 depicts a flow diagram 400 of one method for compressing a route into a plurality of segments 320. Flow diagram 400 is described as it pertains to finding an uphill segment but also pertains to finding a downhill segment.

At step 402, embodiments get route data. Route data may be collected in various ways. For example, route data may be retrieved from an external or third-party source such as GPS source server 32 or may be collected from vehicles 40 traveling along a route or by satellite imagery. Route data may include coordinates corresponding to points along the route. In some embodiments, route data may include only latitude and longitude for each coordinate. In some embodiments, route data may include latitude, longitude and elevation for each coordinate. In some embodiments, route data may include route information such as a speed limit, tolls and other fees. In some embodiments, route data may include route information such as weather conditions, road conditions or traffic conditions such as a current average speed of other vehicles 40 currently traveling along the route, as well as other factors that could affect the time needed for a vehicle 40 to travel along a route.

At step 404, embodiments identify a first point 220. The first point 220 may be determined to be the route start point.

At step 406, embodiments identify a second point 220 adjacent to the first point 220.

At step 408, embodiments determine a distance between the first point 220 and the second point 220.

At step 410, embodiments determine a grade between the first point 220 and the second point 220. Embodiments may determine a change in elevation between the first point 220 and the second point 220 and divide the change in elevation by the distance between the first point 220 and the second point 220 to determine the grade between the first point 220 and the next point 220.

At step 412, embodiments determine if the grade between the first point 220 and the second point 220 exceeds a grade threshold. A grade threshold for an uphill segment 320 may be a positive value, wherein a grade between two adjacent points that is greater than the positive value would exceed the grade threshold. A grade threshold for a downhill segment 320 may be a negative value, wherein a grade between two adjacent points that is less than the negative value would exceed a grade threshold.

At step 414, if the grade between the first point 220 and the second point 220 exceeds the grade threshold, the distance between the first point 220 and the second point 220 is added to the segment distance 308.

If the grade between the first point 220 and the second point 220 does not exceed the grade threshold, then the first point might be the last point 220 for the segment. To determine if the first point 220 is the last point for a segment, embodiments determine if the grade between the first point and the second point 220 represents an exception or is part of a transition to a new segment. At step 416, embodiments increment the exception count and at step 418, embodiments determine if the segment distance 308 is greater than a minimum distance.

If the segment distance is not greater than a minimum distance, the distance between the first point 220 and the second point 220 is added to the segment distance at step 414. This may prevent embodiments from concluding that a segment 320 has ended based on 1-2 variations early in the segment 320.

If the segment distance is greater than a minimum distance, then at step 420 embodiments determine if the exception count exceeds a threshold count. In some embodiments, the exception threshold count is calculated as a ratio of the number of exceptions relative to a segment distance. In some embodiments, exceeding an exception threshold count may cause additional processing. For example, a large number of exceptions may be allowed if the average grade for a segment still exceeds a grade threshold.

If the exception count for a segment distance does not exceed a threshold count, the distance between the first point 220 and the second point 220 is added to the segment distance at step 414.

At step 422, embodiments determine if the second point 220 is the last point in the route data.

If the second point 220 is the last point in the route data, then the method ends.

Referring to step 420, if the exception count for a segment distance exceeds a threshold count, the distance between the first point 220 and the second point 220 is not added to the segment distance at step 414. Embodiments may determine a last point for a segment based on the segment distance associated with a point 220 associated with the segment distance.

At step 426, if the exception count for a segment distance exceeds a threshold count such that embodiments know the segment start point and the segment end point, embodiments determine an average grade for the segment 320. Embodiments may use the segment start point and the segment end point to determine a segment distance and may calculate a grade between the segment start point and the segment end point. In some embodiments, a linear best fit approximation is calculated using all the points 220 associated with a segment 320 (including any exceptions). In some embodiments, a linear best fit approximation is calculated using the points 220 associated with a segment 320 (minus any exceptions). At step 426, embodiments may also determine if the average grade for the segment 320 exceeds a grade threshold.

At step 428, if the average grade for the segment 320 does not exceed a grade threshold, the segment 320 is saved as a flat segment 320.

At step 430, if the average grade for the segment 320 exceeds a grade threshold, the segment 320 is saved as an uphill segment 320 (if the average grade is greater than a positive value associated with an uphill segment 320) or a downhill segment 320 (if the average grade is less than a negative value associated with a downhill segment 320).

Embodiments may repeat steps 406-430 until all route data has been analyzed and compressed into linearized segments 320 that are either uphill segments 320 (with a positive grade greater than a threshold grade), downhill segments 320 (with a negative grade less than a threshold grade) or flat segments 320 with a grade less than the threshold grade for uphill segments 320 and greater than the threshold grade for downhill segments 320.

### Determining Flat Segments

Flat segments 320 may be defined as the segments 320 of the route determined to not be an uphill segment 320 or a downhill segment 320.

### Initial Flat Segment

An initial flat segment 320 may be determined by starting at the first point at the beginning of the route and checking whether the current point on the path is part of an uphill segment 320 or downhill segment 320.

If the current point is not part of an uphill segment 320 or downhill segment 320, then the initial flat segment 320 is determined by identifying the closest uphill segment 320 or downhill segment 320 starting point and selecting that point as the ending point for the flat segment 320.

### Subsequent Flat Segments

Embodiments may identify a flat segment 320 based on an uphill segment 320 or downhill segment 320 determined from the start of the route that is beyond the last point of the last flat segment 320 found.

The uphill segment 320 or downhill segment 320 is based on the shortest distance along the path to the start of the uphill or downhill segment 320. The last point of an uphill segment 320 or a downhill segment 320 may be identified as the first point of the flat segment 320 if the next point on the route is not part of an uphill segment 320 or downhill segment 320. Each flat segment 320 spans from the last point of an uphill segment 320 or downhill segment 320 to the first point of the next uphill segment 320 or downhill segment 320. Route analysis continues using the last point of each uphill segment 320 or downhill segment 320 whose first point was used as the last point of the last flat segment 320 found. The process is repeated until all the flat segments 320 between uphill/downhill segments 320 are found.

### Terminal Flat Segment

Embodiments determine whether the last point on the route is part of an uphill segment 320 or downhill segment 320. If it is not part of an uphill segment 320 or downhill segment 320, embodiments search back from the last point for the uphill segment 320 or downhill segment 320 whose distance is furthest from the beginning of the route. The last point on the uphill segment 320 or downhill segment 320 found above becomes the first point of the terminal flat segment 320. The last point of the route is the last point of the terminal flat segment 320.

Each flat segment 320 is saved with the first and last points of the segment 320, distance from the start of the route, the grade of the flat segment 320 and the flat segment span distance.

Route data may comprise point having coordinates retrieved from a route information server. Each point may have a latitude and a longitude. Elevation data may be associated with each point. For example, in some embodiments, elevation data from the U.S. Geological Service may be associated with each coordinate. USGS elevation data along roads is noisy and there are places where elevations are clearly incorrect, as the resulting grade of the road would exceed any actual grade found on roads. In these situations, the points that result in such grades may be adjusted such that all the resulting grades between points are reasonable.

Vehicles May have Different Drivetrain Configurations

Segment information may be the same for all vehicles 40 traveling on the same segment 320. However, different vehicles 40 traveling on the same segment 320 may have different drivetrain configurations such that no single performance plan is possible for all vehicles 40 traveling the same segment 320.

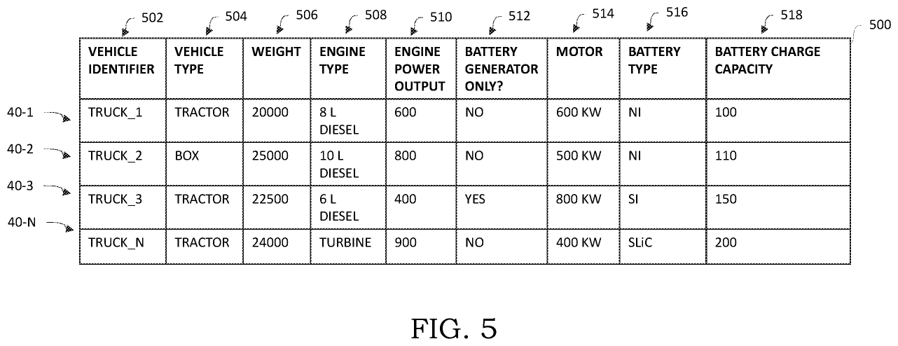

FIG. 5 is a data structure 500 for a plurality of vehicles 40, wherein data structure 500 depicts example vehicle drivetrain configuration information in table format. As depicted in FIG. 5, data structure 500 may include, for each vehicle 40 of a plurality of vehicles 40, vehicle drivetrain configuration information including a vehicle identifier 502, a vehicle type 504, a gross weight 506, an engine type 508, an engine power output 510, an indication if the engine is to be used for electric power generation only 512, a motor power capacity 512, motor information 514, battery type 516 and battery charge capacity 518, and may include other vehicle drivetrain configuration information as well.

Vehicle type column 504 may store information on a type of vehicle 40, such as whether the vehicle 40 is a tractor, a box truck, a bus, or some other type of vehicle 40. Weight column 506 may comprise information about a weight of each vehicle 40. Engine type column 508 may comprise information on a type of engine installed in each vehicle 40. Examples of engine types include an internal combustion (IC) engine (also referred to as an ICE) that may be configured to operate using gasoline, diesel, natural gas (NG) including compressed natural gas (CNG), liquid natural gas (LNG) and renewable natural gas (RNG), or other types of engine including, but not limited to gas turbines and fuel cells, which may operate on hydrogen, natural gas, propane or some other fuel source. Engine power output column 510 may comprise information about how much power can be supplied by the engine type provided in engine type column 508.

Column 512 may comprise information about whether vehicle 40 is configured with an engine used for generating electric power only or whether the engine may be used to directly provide rotational power to one or more axles to drive vehicle 40.

Column 514 may comprise information about a motor/generator installed in each vehicle 40.

Column 516 may comprise information about what type of battery system is installed in each vehicle 40. Battery chemistry, the number of batteries in the battery system, the operating limits of a battery system and other operating parameters may differ between vehicles 40.

Column 518 may comprise information about a battery capacity for a battery system installed in each vehicle 40. Improvements in battery chemistry and packaging may allow increased battery capacity.

Other columns with additional information may be stored in data structure 500. Vehicle configuration information may be stored in vehicle information storage 24. In some embodiments, operations server 10 may communicate with engineering server 24 and/or vehicles 40 to get vehicle configuration information. For example, operations server 10 may communicate with engineering server 24 to get information about a type of battery in a particular vehicle 40 and may communicate with that vehicle 40 to determine a battery state of charge (SOC). Other examples of vehicle information that may be received or retrieved from engineering server 24 and/or a particular vehicle 40 about that particular vehicle include a fuel level, a battery temperature, a fuel efficiency associated with the engine providing only rotational power to the one or more axles, a fuel efficiency associated with the engine providing rotational power to the one or more axles and providing rotational power to a motor/generator to generate electric power, and a fuel efficiency associated with the engine providing only rotational power to the motor/generator to generate electric power.

### Performance Plans Sent to Different Vehicles are Based on Ensuring Each Vehicle Drivetrain Configuration is Capable of Completing its Intended Route

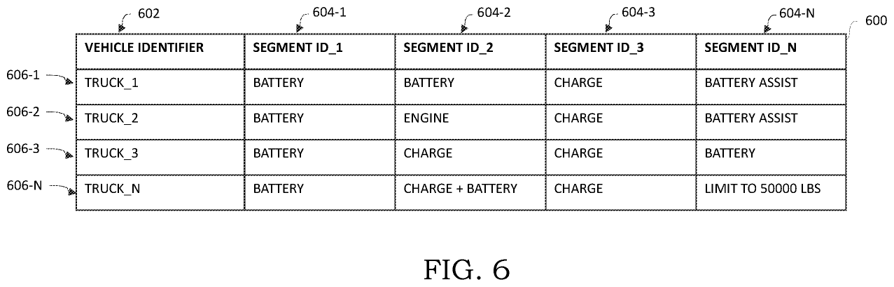

FIG. 6 is a data structure 600 depicting example vehicle performance plan information in table format. Using the methods described above with the data stored in one or more data structures described above, embodiments may determine a performance plan for a vehicle 40 or a plurality of vehicles 40.

A performance plan may specify a set of operating parameters for a vehicle 40 with a particular configuration comprising an engine, a motor configurable as a motor or a generator, and a battery system. A performance plan may specify a set of operating parameters for each segment in a route or each segment in a portion of the route. FIG. 6 depicts a data structure 600 storing a plurality of performance plans 606. Each performance plan 606 may be associated with a particular vehicle 40 and a particular route. Performance plan 606-1 may comprise a set of operating parameters for a first vehicle 40 (identified in vehicle identifier column 602 as Truck_1) and for each segment 604 identified in segment columns 604-1 to 604-N. It should be noted that the number of segments 604 for each vehicle 40 may vary such that performance plan 606-1 may include operating parameters for Truck_1 operating over a route having a first plurality (e.g., 35) segments and performance plan 606-2 may include operating parameters for Truck_2 operating over a route having a second plurality (e.g., 42) segments. Furthermore, each performance plan 606 depends on a vehicle configuration. Thus, even if two vehicles 40 (e.g., Truck_1 and Truck_2) are traveling over the same route, a first vehicle 40-1 may receive a different performance plan 606 than a second vehicle 40-2. A performance plan may specify which segments a vehicle 40 should use electric power supplied from a battery system to operate a motor to drive the vehicle 40, which segments a vehicle 40 should use electric power supplied from a battery system to operate a motor and use an engine to generate rotational power to drive the vehicle 40, which segments a vehicle 40 should use regenerative braking to charge a battery system, which segments a vehicle 40 should use regenerative braking to charge a battery system and brake the vehicle, which segments a vehicle 40 should coast, and which segments a vehicle 40 should operate to cool the battery system. In some embodiments, a performance plan 606 may specify one or more of an engine operating parameter or a range of operating parameters, a vehicle speed range or a maximum vehicle speed, a motor operating parameter or a range of motor operating parameters, a generating operating parameter or a range of generator operating parameters, a battery state of charge (SOC), a minimum battery SOC at the beginning or end of a segment, a maximum battery SOC at the beginning or end of a segment, a maximum rate of charging the battery system, a minimum fuel level at the beginning or end of the segment, a minimum fuel efficiency while operating in the segment, a maximum emission output while operating in the segment or some other operating parameter.

Multiple Vehicles with Changing Cargo Loads

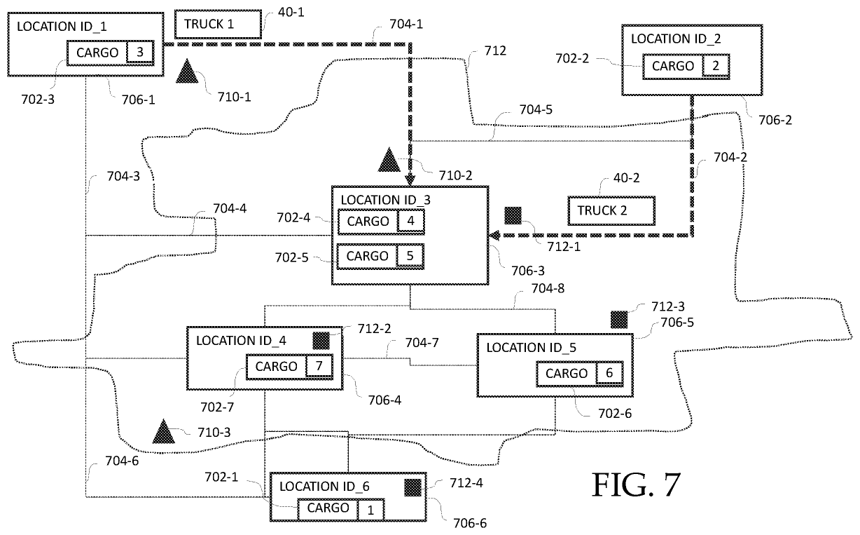

Vehicles 40 are used to transport cargo between locations in a geographic area. A geographic area may be relatively small (within a metropolitan area) or very large (within a continent). FIG. 7 depicts a graphical representation of a geographic area in which multiple vehicles 40 operate to deliver cargo loads 702. Furthermore, within the geographic area, there may be multiple routes 704 between multiple locations 706. Each location 706 may be have one or more cargo loads 702 intended for another location 706 or may be designated as an end point for one or more cargo loads 702.

A route 704 may start, end or be inside or outside of a predefined geographic zone 712 within the geographic area. In some situations, a geographic zone 712 may be defined as a city or other municipality. A geographic zone 712 may be associated with rules or regulations pertaining to vehicles 40. For example, geographic zone 712 may correspond to a zero-emission zone in which only vehicles 40 that do not produce carbon emissions are allowed within geographic zone 712. Other geographic zones 712 may be associated with rules that restrict the level of carbon emissions below a threshold emission level, restrict noise, vehicle weight or otherwise affect one or more of the configuration of vehicles 40 or the operation of vehicles 40.

Embodiments may receive cargo information about one or more cargo loads 702 and determine a performance plan (such as performance plan 606 described above) for a vehicle 40 selected to transport the cargo load 702 over a route 704 from a first location 706 to a second location 706. Embodiments may receive cargo information about a large plurality of cargo loads 702, determine a plurality of vehicles 40 for transporting the cargo loads 702, and determine a performance plan (such as performance plan 606 described above) for each vehicle 40 selected to transport a cargo load 702 over a route 704 from a first location 706 to a second location 706.

Vehicles 40 will need to either operate using an engine to supply rotational power to an axle or operate using the engine to supply rotational power to a generator to charge a battery system or connecting the battery system to a charging station to ensure the vehicle 40 can travel over a route. As depicted in FIG. 7, embodiments may determine the location of fuel stations 710 or charging stations 712 for determining when and how to charge a battery system. Fuel stations 710 and

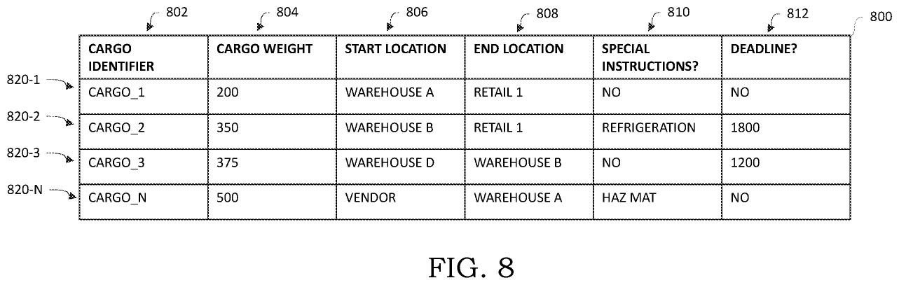

FIG. 8 depicts a table data structure 800 containing cargo information for a plurality of cargo loads 702. Each row 820 may include information about a cargo load 702, wherein cargo identifier column 802 contains a cargo identifier, cargo weight column 804 contains a cargo weight, cargo start location column 806 contains a start location, cargo end location column 808 contains an end location, cargo instructions column 810 contains special instructions related to a cargo load 702 (e.g., if the cargo load 702 must be refrigerated or contains hazardous materials (HAZ MAT) and cargo load deadline column 812 contains information about a deadline at which time the cargo load 702 must be at the cargo load end location.

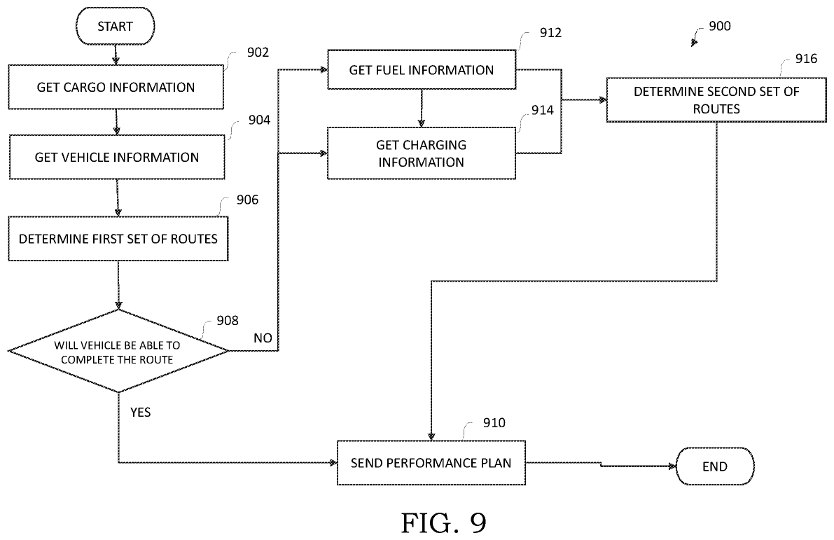

FIG. 9 depicts a flow diagram 900 depicting a method for controlling a plurality of vehicles 40 over a plurality of routes in a geographic area.

At step 902, embodiments get cargo load information. In some embodiments, cargo tracking server 16 is communicatively coupled to a database storing cargo load information. In some embodiments, cargo tracking server 16 is communicatively coupled to a network that allows a user to input cargo load information.

At step 904, embodiments get vehicle information for a set of vehicles 40. In some embodiments, vehicle configuration server 14 communicates with vehicles 40 to get vehicle information for each vehicle 40 capable of transporting a cargo load 702. In some embodiments, vehicle configuration server 14 communicates with warehouses or other facilities to get vehicle information for each vehicle 40 capable of transporting a cargo load 702.

At step 906, route planning server 12 determines a first set of routes 704 for transporting cargo loads 702 between locations 706. In some embodiments, route planning server 12 communicates with cargo tracking server 16 to determine a set of locations 706 associated with receiving or delivering a cargo load 702, identifies a set of vehicles 40 to get vehicle information for each vehicle 40 capable of transporting a cargo load 702 and determines a first set of routes 704 based on the cargo information and the vehicle configuration information. In some embodiments, route planning server 12 gets one or more of a speed limit, road conditions, weather conditions and traffic conditions including an average speed of other vehicles 40 and determines a first set of routes 704 based on the cargo information, the vehicle configuration information and one or more of the speed limit, road conditions, weather conditions and traffic conditions including an average speed of other vehicles 40 traveling on the route 704.

At step 908, embodiments determine if each vehicle 40 is configured or capable of being configured to complete the route 704. In some embodiments, determining if each vehicle 40 is configured or capable of being configured to complete the route 704 may be based on the amount of fuel in a fuel tank or the state of charge in a battery system on the vehicle 40. In some embodiments, determining if each vehicle 40 is configured or capable of being configured to complete the route 704 may be based on the amount of power that an engine or motor is capable of supplying to a set of axles. In some embodiments, determining if a vehicle 40 is configured to complete a route may include determining if the vehicle 40 is configured to complete each segment in the route.

At step 910, if each vehicle 40 is configured or capable of being configured to complete the route, embodiments may communicate a performance plan 606 to each vehicle 40. In some situations, a performance plan 606 is communicated to operations server 10 for cost analysis, environmental impact or for predicting service life of the vehicle 40, discussed in greater detail below. In some situations, a performance plan 606 is communicated to a vehicle 40 traveling along a route 704, discussed in greater detail below.

At step 912, if the vehicle 40 is not configured or configurable to complete the route based on a battery state of charge (SOC) being below a threshold SOC and the fuel level for the vehicle 40 is too low for the vehicle 40 to operate the engine to charge the battery system, embodiments may get fuel information, which may include communicating with servers over a network to identify fuel locations and charging stations. In some embodiments, power planning server 18 may determine all fuel locations with fuel below a selected price or select a fuel location with a lowest price and communicate a fuel location or a set of fuel locations to route planning server 12.

At step 914, if the vehicle is not configured or configurable to complete the route based on a fuel level being below a minimum fuel level, route planning server 12 may communicate with power planning server 18 to determine a charging station where battery charging may occur. Power planning server 18 may determine all charging stations with battery charging rates that are below a selected price or select a charging station with a lowest price.

At step 916, route planning server 12 may determine a second set of routes 704 based on a fuel location or battery charging location.

At step 910, route planning server 12 may communicate the performance plan 606 based on the second set of routes 704 to a set of vehicles 40. In some situations, a performance plan 606 is communicated to the operations server 10 for cost analysis, environmental impact or for predicting service life of the vehicle 40, discussed in greater detail below. In some situations, a performance plan is communicated to a vehicle 40 traveling along a route, discussed in greater detail below.

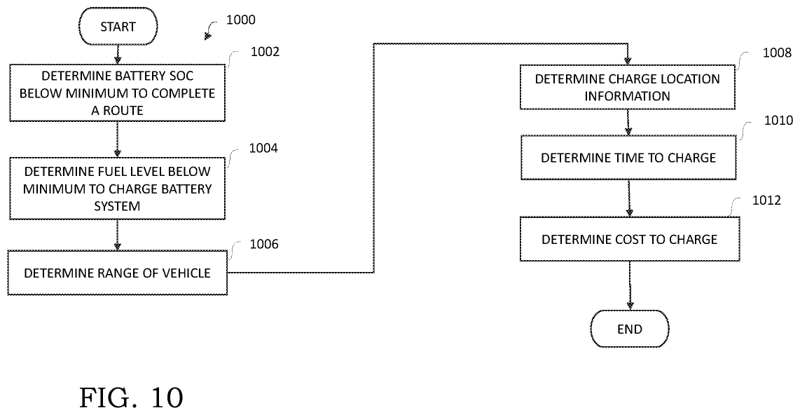

FIG. 10 depicts a flow diagram 1000 of a method for determining charging cost for a vehicle 40.

At step 1002, embodiments may determine a battery state of charge (SOC) is below a minimum SOC for the vehicle 40 to complete a route. In some situations, a controller on board vehicle 40 determines when the battery SOC is near a minimum SOC. In some situations, vehicle 40 communicates battery information to operations server 10 and operations server 10 determines when a battery state of charge (SOC) is below a minimum SOC for the vehicle 40 to complete a route charge location information.

At step 1004, embodiments determine a fuel level of vehicle 40 is below a minimum fuel level for vehicle 40 to operate an engine to charge the battery system. In some situations, a controller on vehicle 40 determines when the fuel level is near a minimum fuel level to charge the battery system to a level sufficient to complete a route. In some situations, vehicle 40 communicates fuel level information to operations server 10 and operations server 10 determines when the fuel level is below a minimum fuel level for an engine on the vehicle 40 to generate rotational power for the motor/generator to supply enough electrical power to charge the battery system. In some situations, vehicle 40 communicates fuel level information to operations server 10 and operations server 10 determines when the fuel level is below a minimum fuel level for an engine on the vehicle 40 to generate rotational power for the motor/generator to supply enough electrical power to charge the battery system and the amount of electrical power the motor/generator can generate using regenerative braking is not enough to charge the battery system to complete the route.

At step 1006, embodiments determine a range of the vehicle 40. Determining a range of the vehicle may include determining a range based on using only battery power, a range based on using only engine power supplied to an axle, a range based on using engine power to charge the battery system and any combination. Determining a range of the vehicle 40 may further include determining if the vehicle 40 can operate using the engine. For example, in some geographic zones or areas, vehicle 40 may be limited (including prevented) from operating engine due to emissions limitations. Thus, vehicle 40 may have sufficient fuel to charge a battery system using an engine but might not be able to due to environmental impact.

At step 1008, embodiments determine possible charge station information based on the range of the vehicle 40. Determining charge location information may comprise communicating with operations server 10 to determine a maximum cost rate (e.g., $/kWh) for charging and searching for charging locations along a route 704 within the range of the vehicle 40 and that have a charging rate less than or equal to the maximum charging rate.

At step 1010, embodiments may determine a time needed to charge a battery system in vehicle 40. Determining the time needed to charge a battery system in vehicle 40 may comprise communicating with vehicle 40 to determine a projected battery SOC when the vehicle 40 reaches the charging station and the rate at which the battery system can be charged to a desired battery SOC. The rate at which the battery system can be charged to a desired battery SOC may depend on the type of batteries in the battery system.

At step 1012, embodiments may determine a cost to charge the battery system in vehicle 40. Determining a cost to charge the battery system may comprise communicating with vehicle 40 to determine a SOC of the battery system when the vehicle 40 reaches the charging station and the amount of power needed to charge the battery system. The amount of power needed to charge the battery system may depend on the ambient air temperature, a battery temperature, losses due to the type of charging being performed by the charging station and may include other information such as the time of day. For example, a cost to charge a battery system may be higher during peak electricity usage periods. A cost to charge a battery system may be higher during peak electricity usage times such as 8 am to 8 pm, Monday-Friday.

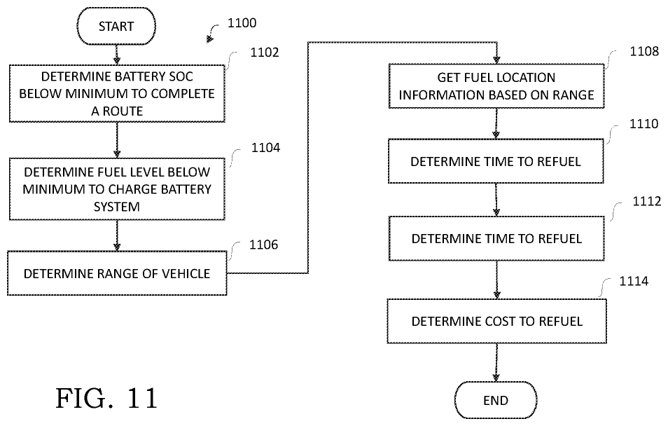

FIG. 11 depicts a flow diagram 1100 of a method for determining fuel costs associated with charging batteries on a vehicle 40.

At step 1102, embodiments may determine a battery state of charge (SOC) is below a minimum SOC for the vehicle 40 to complete a route. In some situations, a controller on board vehicle 40 determines when the battery SOC is near a minimum SOC. In some situations, vehicle 40 communicates battery information to operations server 10 and operations server 10 determines when a battery state of charge (SOC) is below a minimum SOC for the vehicle 40 to complete a route charge location information.

At step 1104, embodiments determine a fuel level of vehicle 40 is below a minimum fuel level for vehicle 40 to operate an engine to charge the battery system. In some situations, a controller on board vehicle 40 determines when the fuel level is near a minimum fuel level to charge the battery system to a level sufficient to complete a route. In some situations, vehicle 40 communicates fuel level information to operations server 10 and operations server 10 determines when the fuel level is below a minimum fuel level for an engine on the vehicle 40 to generate rotational power for the motor/generator to supply enough electrical power to charge the battery system. In some situations, vehicle 40 communicates fuel level information to operations server 10 and operations server 10 determines when the fuel level is below a minimum fuel level for an engine on the vehicle 40 to generate rotational power for the motor/generator to supply enough electrical power to charge the battery system and the amount of electrical power the motor/generator can generate using regenerative braking is not enough to charge the battery system to complete the route.

At step 1106, embodiments determine a range of the vehicle 40. Determining a range of the vehicle 40 may include determining a range based on using only battery power, a range based on using only engine power supplied to an axle, a range based on using engine power to charge the battery system and any combination. Determining a range of the vehicle 40 may further include determining if the vehicle 40 can operate using the engine. For example, in some geographic zones or areas, vehicle 40 may be limited (including prevented) from operating an engine due to emissions limitations. Thus, vehicle 40 may have sufficient fuel to charge a battery system using an engine but might not be able to due to environmental impact. Determining a range of the vehicle 40 may include determining vehicle losses. For example, losses due to wind resistance increase with vehicle speed and rolling resistance may vary based on the type of road surface. Embodiments may determine a speed limit for the route and use the speed limit to determine losses due to wind resistance, wherein the losses due to wind resistance may be used when calculating a range. Also, a vehicle 40 with a refrigerated cargo trailer requires more energy to cool the trailer than a vehicle 40 with a non-refrigerated or flatbed trailer.

At step 1108, embodiments may determine fuel location information. Determining fuel location information may comprise communicating with vehicle 40 to determine a range of the vehicle 40 based on the available battery SOC and/or a range based on an engine operating to generate electric power and/or a range based on engine operation. Determining fuel station location information may comprises communicating with operations server 10 to determine a maximum fuel rate (e.g., $/gallon) for fuel.

At step 1110, embodiments may determine a time needed to refuel vehicle 40. Determining the time needed to refuel vehicle 40 may comprise communicating with vehicle 40 to determine a projected fuel level when the vehicle 40 reaches the fuel station location and the rate at which fuel may be added to vehicle 40.

At step 1112, embodiments may determine a cost to refuel vehicle 40. Determining a cost to refuel vehicle 40 may comprise communicating with vehicle 40 to determine a fuel level when the vehicle 40 reaches the fuel station and the amount of fuel needed. The amount of fuel needed may depend on the battery SOC needed to complete the route 704 and the conversion rate between fuel and battery SOC.

Vehicle Configurations May Reduce Costs and Emissions and have a Longer Service Life

Embodiments described above may allow vehicles 40 to be configured with drivetrains comprising an engine coupled only to a motor/generator such that the engine is used to generate electric power only. In these embodiments, the motor/generator may be agnostic to the engine such that the selection of which engine to install in a vehicle 40 may be based on a fuel type. Vehicle configurations with an engine coupled only to a motor/generator may facilitate installation of high density engines with smaller displacements. For example, embodiments may utilize a conventional diesel engine with a displacement between 6-12 liters instead of a 15 liter displacement. A smaller an engine may be configured to operate at higher engine speeds for greater burn efficiency and generate more heat per volume of air.

In some embodiments, vehicle configurations may allow a decontented engine, whereby the engine is mechanically coupled only to a motor/generator and any power needed by accessories comprises electrical power drawn from a battery system or generated by the engine supplying rotational energy to the motor/generator. By way of background, in a traditional drivetrain for vehicle, an engine is mechanically coupled to a water pump and coupled to accessories via a belt. The accessories may include an air conditioning (A/C) compressor, an alternator, a power steering pump and an air compressor. Thus, the engine in a traditional drivetrain needs to be large enough to propel the vehicle and provide rotational power to the water pump and all accessories associated with the belt. The additional power demands result in the engine being required to operate over a wide range of operating speeds and loads, adding cost and complexity.

In some embodiments, vehicles 40 may be configured with engines coupled to motor/generators such that the motor/generator replaces the alternator and power generated by the motor/generator operates a water pump and any accessories. Using this configuration, the displacement and overall size associated with an engine may be reduced and components and accessories may be located elsewhere in an engine compartment or elsewhere on a chassis of the vehicle 40. Furthermore, an engine coupled to only a motor/generator and configured to provide rotational power only to the motor/generator may be able to operate within a preferred or optimal operating range for reduced environmental impact. In some embodiments, a decontented engine coupled to a motor/generator may be easier to start using battery power such that the motor/generator performs the functionality usually associated with a dedicated starter motor. Elimination of a dedicated starter motor may further reduce the overall size associated with the engine and may simplify installation and removal of the engine from a vehicle 40.

Embodiments of vehicles 40 configured with an engine coupled only to a motor/generator such that the engine is used to generate electric power only may allow the engine to operate within a preferred operating range. A motor/generator coupled to an engine may be sized based on an operating range of the engine. The ability to operate an engine within a preferred operating range may increase the efficiency and/or service life of the engine. In some embodiments, a vehicle 40 may use a decontented engine with a lower rating or durability by operating the engine within a smaller operating range. For example, a diesel engine may have an operating range of 800-6000 RPM, a preferred operating range of 1200-2400 RPM and an optimal operating range of 1500-1800 RPM. Operating the engine within an optimal operating range may result in reduced emissions and a longer service life for the engine and/or motor generator and/or battery system.

In some embodiments, a vehicle 40 may have a vehicle controller configured to receive a performance plan and operate an engine to charge a battery system or adjust an operating parameter of a battery system based on the performance plan. In some scenarios, communication between a vehicle 40 and operations server 10 may be unavailable and a vehicle 40 may have a vehicle controller configured to determine future power needs and operate an engine to charge a battery system or adjust an operating parameter of a battery system. Thus, a vehicle 40 may use a performance plan as a general solution for how to operate the vehicle 40 and tailor the performance plan to the vehicle 40 based on present operating conditions (e.g., ambient air temperature, traffic, etc.) and present operating parameters (e.g., battery temperature, battery SOC, fuel level, etc.) and may also operate the vehicle 40 in the event a performance plan is unavailable.

In some embodiments, a vehicle controller may determine a weight of the vehicle 40. Determining a weight of the vehicle 40 may include the vehicle controller performing one or more of: determining if a trailer is coupled to the vehicle 40, receiving an input from a driver, or communicating over a network with a weigh station or other external source to receive a vehicle weight. Determining a weight of vehicle 40 may also include a vehicle controller indirectly determining the weight, such as by determining a load on an engine or power drawn from a battery system, determining a fuel consumption rate by an engine, determining a discharge rate of a battery system, or determining a temperature increase of a battery system. In some embodiments, a vehicle controller may compare weight estimations against information input from a driver or received from a weigh station or other external source to calibrate sensors or determine when maintenance is needed.

Information associated with the weight of a vehicle 40 may be used to manage the operating temperature and performance of a battery system and an engine over a segment. For example, a vehicle controller may determine the weight of vehicle 40 is at or near a maximum weight and calculate, based on the maximum weight, how much power is needed to move vehicle 40 on a highway at a desired speed. In some embodiments, a vehicle controller may determine a weight of a vehicle 40 and calculate how much energy may be regenerated using a regenerative braking system. In some embodiments, a vehicle controller may determine the weight of a vehicle 40, analyze the route or terrain, and determine when to charge a battery system or if an engine is needed to provide direct power to assist a motor/generator. In some embodiments, a vehicle controller may determine the weight of vehicle 40, analyze the route or terrain, and determine how much regenerative power is available to charge a battery system including coast down charging. In some embodiments, a vehicle controller may receive an input from a driver or communicate over a network with a server to identify a route and charge a battery system based on the route, including terrain on the route. In some embodiments, a vehicle controller analyzes topographical data and adjusts the performance, the state of charge (SOC) and the operating temperature of a battery system and/or the performance of an engine based on the topographical data.

A vehicle controller may also monitor system performance to determine component performance. For example, a vehicle controller may analyze power compared with vehicle speed to determine an efficiency of a motor/generator or an engine. Information may be used to determine when to service the vehicle 40 including an engine, a motor/generator, a battery system, axles, a refrigerant system or a coolant system. In some embodiments, a vehicle controller may determine an ambient air temperature and calculate how much power a vehicle 40 will need to cool a battery system below a threshold level based on the ambient air temperature. Information may be stored in memory on vehicle 40 or communicated using a network to operations server 10 for predicting maintenance needs.

Operations server 10 may monitor operating conditions and control when charging can occur and may communicate with a driver when to plug in to a charging port, when to operate an engine and when to operate using a battery system. In some embodiments, if the ambient air temperature is below a minimum temperature such that a battery system is expected to perform poorly or below a minimum threshold, operations server 10 may communicate a performance plan to vehicle 40 with instructions to operate vehicle 40 such that heat is added to the battery system to maintain an operating temperature of the battery system above a minimum temperature threshold. In some embodiments, a vehicle controller may monitor the operating temperature of a battery system and turn on an engine and open a coolant system to add heat to the battery system. In some embodiments, a vehicle controller may determine vehicle 40 is in a high pollution area and operate on battery power or manage how or when an engine is used to charge the battery system based on pollution levels.

In some embodiments, a vehicle controller may communicate periodically with operations server 10 to receive a performance plan or an update to a performance plan. Each time a performance plan is received, the controller is configured to use the new performance plan and store the new performance plan in memory accessible by the controller. In the event that connectivity is interrupted or the controller is unable to communicate with operations server 10, the controller may be configured to operate the vehicle 40 according to the most recent performance plan stored in memory. In some embodiments, a performance plan may be communicated to the vehicle 40 every few minutes (e.g., every five minutes) but contain a performance plan for the vehicle that specifies operating parameters for a large portion of the route (e.g., 25 miles). Thus, if the vehicle 40 does not receive an update to a performance plan, the controller may still operate the vehicle 40 according to a performance plan.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1.-18. (canceled)

19. A method comprising:
communicating a route for a vehicle;
determining a plurality of route segments for the route;
determining, a segment grade and a segment distance for each route segment;
determining a vehicle configuration for the vehicle, the vehicle configuration comprising:
a fuel-fed engine capable of generating rotational power;
a battery system; and
a motor/generator configurable as a generator to convert rotational power received from the engine to electrical power and configurable as a motor to convert electrical power received from the battery system to rotational power to drive the vehicle;
generating a performance plan for the vehicle based on the vehicle configuration and each of the plurality of route segments, wherein the performance plan identifies one or more route segments over which the vehicle is configured with the motor/generator operating as the motor to drive the vehicle and identifies one or more route segments over which the vehicle is configured with the motor/generator operating as the generator to generate electric power to charge the battery system;
communicating the performance plan to the vehicle; and
operating the vehicle over each of the plurality of route segments in accordance with the performance plan.

20. The method of claim 19, wherein the performance plan identifies one or more route segments over which the vehicle is configured with the engine generating rotational power to drive the vehicle and supplying rotational power to the motor/generator operating as the generator to charge the battery system.

21. The method of claim 19, wherein the performance plan identifies one or more route segments over which the vehicle is configured with the motor/generator operating as the generator and configured to receive rotational power from an axle of the vehicle to generate electric power to charge the battery system.

22. The method of claim 19, further comprising:
determining, for the route, a route segment having an uphill grade;
determining a vehicle weight for the vehicle;
determining, based on the vehicle weight and the uphill grade:
an output power needed by the motor/generator configured as the motor to generate rotational power to drive the vehicle over the route segment; and
a change in a battery state of charge caused by the battery system supplying electric power to the motor/generator to drive the vehicle over the route segment.

23. The method of claim 22, wherein generating the performance plan further comprises:
determining an operating cost, an environmental impact, a change in battery temperature, or a combination thereof over the route segment.

24. The method of claim 19, further comprising:
determining, for the route, a route segment having a downhill grade;
determining a vehicle weight for the vehicle;
determining, based on the vehicle weight and the downhill grade:
an electric power generated by the motor/generator operating as the generator; and
a change in a battery state of charge caused by the motor/generator supplying electric power to the battery system over the route segment.

25. The method of claim 24, wherein generating the performance plan further comprises:
determining an operating cost, an environmental impact, a change in battery temperature, or a combination thereof over the route segment.

26. The method of claim 19, further comprising: communicating with a controller on the vehicle to receive an operating parameter of the vehicle.

27. The method of claim 19, further comprising: determining a cargo load, wherein generating the performance plan is based on the vehicle configuration and the cargo load.

28. The method of claim 19, wherein each route segment comprises one or more of a road surface, a road type, and a traffic rating for a segment.

29. The method of claim 19, wherein each uphill segment is defined by an average grade that exceeds a minimum grade threshold and a segment distance that is greater than a defined minimum distance.

30. The method of claim 29, wherein determining an uphill segment comprises:
determining, for two points corresponding to adjacent points on the route, a grade between the two points, wherein:
if the grade is equal to or greater than an uphill grade threshold, a distance between the two points is added to the segment distance and the grade is added to a segment grade;
if the grade is less than the uphill grade threshold but a number of exceptions is less than a threshold exception count, the distance between the two points is added to the segment distance and the grade is added to the segment grade; or
if the grade is less than the uphill grade threshold and a number of exceptions is greater than a threshold exception count, one of the two points is identified as a last point for the segment and the segment is stored as an uphill segment.

31. The method of claim 19, wherein each downhill segment is defined by an average grade that is less than a defined downhill threshold and a segment distance that is greater than the defined minimum distance.

32. The method of claim 31, wherein determining a downhill segment comprises:
determining, for two points corresponding to adjacent points on the route, a grade between the two points, wherein:
if the grade is equal to or less than a downhill grade threshold, a distance between the two points is added to the segment distance and the grade is added to a segment grade;
if the grade is greater than the downhill grade threshold but a number of exceptions is less than a threshold exception count, the distance between the two points is added to the segment distance and the grade is added to the segment grade; or
if the grade is greater than the downhill grade threshold and a number of exceptions is greater than a threshold exception count, one of the two points is identified as a last point for the segment and the segment is stored as a downhill segment.

33. The method of claim 19, wherein each flat segment is defined as a segment determined to not be an uphill segment or a downhill segment and comprises a segment distance that is greater than a defined minimum distance, and wherein identifying a flat segment comprises:
determining a last point in an uphill segment or a downhill segment;
determining a next point in the route data as a first point in the flat segment;
determining a first point in a subsequent uphill segment or downhill segment; and
determining a previous point in the route data as a last point in the flat segment.
